(19) United States
(12) Patent Application Publication
(10) Pub. No.: US 2012/0297294 A1
(43) Pub. Date: Nov. 22, 2012

(54) NETWORK SEARCH FOR WRITING ASSISTANCE

(75) Inventors: Matthew Robert Scott, Beijing (CN); Ming Zhou, Beijing (CN); Duo Ding, Shanghai (CN); Xingping Jiang, Beijing (CN); Jonathan Y. Tien, Beijing (CN); Gang Chen, Beijing (CN); Hsiao-Wuen Hon, Bellevue, WA (US); Andrea Jessee, Redmond, WA (US)

(73) Assignee: MICROSOFT CORPORATION, Redmond, WA (US)

(21) Appl. No.: 13/109,021

(22) Filed: May 17, 2011

(51) Int. Cl. G06F 17/21; G06F 17/30

(52) U.S. Cl. 715/261; 715/256; 715/264

(57) ABSTRACT

Architecture that utilizes web search implicitly to assist users in improving writing and associated productivity. The architecture extends the authoring experience of applications of office suite applications which can draw on a web search engine to offer contextual suggestions for revision, word auto-complete, and text prediction. Web-based research and reference to users is enabled as the user writes or revises text. Suggestions are made as to how to complete a phrase or sentence using data from networks such as the Internet or intranet, to how a user how revises a word or phrase in an already-written sentence using data from the network, and to problems in writing style/writing rules. Paragraph analysis is performed to find improper language usage or errors. Prediction and revision suggestions are extracted from web search or enterprise search document summaries, and intent of the user to obtain word completion, revision assistance, and prediction suggestions is identified.

### BACKGROUND

Both native and non-native language speakers of a language use web search extensively while writing for reasons such as unblocking writer block, social proof by examining web search hit counts for similar expressions, research, usage examples, reference (e.g. dictionary/thesaurus), etc. Generally, the web is being used to assist writers think and write better, in more productive way. However, this is not convenient. Writers oftentimes manage multiple windows, a word processor and a web browser, perform operations such as copy and paste, as well as switching between experiences. Moreover, spelling and grammar checking is not available, bilingual results cannot be provided, capabilities such as a thesaurus are not provided, and so on.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture utilizes web search implicitly to assist users to write better and more productively. The architecture extends the authoring experience of applications of office suite applications which can draw on a web search engine to offer contextual suggestions for revision, word auto-complete or text prediction, for example. Additionally, web-based research and reference to users is enabled as the user writes or revises text.

More specifically, suggestions are made to a user as to how to complete a phrase or sentence using data from networks such as the Internet or intranet, as to how a user how revises a word or phrase in an already-written sentence using data from the network, as to problems in writing style/writing rules, and so on. Paragraph analysis is performed to find improper language usage or errors. Prediction and revision suggestions are extracted from web search or enterprise (intranet) search document summaries (snippets), and intent of the user to obtain word completion, revision assistance, and prediction suggestions is identified.

Tooltips are generated from Internet or intranet data to provide reference, research, and usage examples. Implicit and explicit methods are employed to determine when to trigger suggestions (e.g., writer's block detection (implicit), keyboard shortcut (explicit), etc.).

The architecture is amenable for multi-lingual users. Accordingly, second-language users can be inferred, and bilingual inline results obtained. Suggestions by an inferred language comprehension level (e.g., English) can be ranked. A feature referred to as web sort can rank suggestions by statistical occurrence in a large corpus. Web sort assists users as a social proof with implicit collocation information.

Word processor auto-complete suggestions are provided that draw on context (nearby words), prefix matching, wild card, and fuzzy matching (e.g., phonetic search, spelling checking, prefix matching, and transliteration). Additionally, automatic bibliographic citation is provided as well as application suite integration (e.g., office suites).

The textual sensing and suggestion capabilities can also be applied to the more technical scenarios such as integrated development environment (IDE) and programming language development, for example, where the search engine, dictionaries and language models are focused on the software language usage rather than native language usage.

The disclosed architecture is not limited to a single network such as the Internet, but can also operate over multiple networks such as both the Internet and an intranet to obtain the desire results, and cloud infrastructures for mobile devices, for example.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an assistance system in accordance with the disclosed architecture.

FIG. 2 illustrates a high level diagram of an assistance system in accordance with the disclosed architecture.

FIG. 3 illustrates an exemplary algorithm for revision processing.

FIG. 4 illustrates a system of tooltip providers.

FIG. 5 illustrates an example user interface for revision and tooltip with contextual network-mined reference.

FIG. 6 illustrates a user interface that presents a second language of the user.

FIG. 7 illustrates a user interface for sentence completion and inline research while writing.

FIG. 8 illustrates a user interface for predictive suggestions.

FIG. 9 illustrates a user interface for word complete suggestions.

FIG. 10 illustrates a user interface for a contextual speller.

FIG. 11 illustrates a user interface for quotation sentence completion.

FIG. 12 illustrates a user interface for a web sort feature.

FIG. 13 illustrates a paragraph analysis algorithm to find language usage mistakes and semantic errors.

FIG. 14 illustrates a computer-implemented assistance method in accordance with the disclosed architecture.

FIG. 15 illustrates further aspects of the method of FIG. 14.

FIG. 16 illustrates an alternative computer-implemented assistance method in accordance with the disclosed architecture.

FIG. 17 illustrates further aspects of the method of FIG. 16.

FIG. 18 illustrates a block diagram of a computing system that executes writing assistance and searching in accordance with the disclosed architecture.

### DETAILED DESCRIPTION

With the vast numbers of sentences available on the Internet, much of what people might want to write has already been written and can be searched. Therefore, Internet data can be utilized via search and/or a web-scale language models to predict how a written thought could end, how to complete a word, and even how to revise what has already been written. Though the Internet is full of noise and linguistic imperfections, the sheer statistical weight of such massive data makes identifying erroneous language as outliers possible.

The disclosed architecture finds particular application to multi-lingual users (e.g., English native users and English-as-a-second-language (ESL) users). In this context, the architecture adapts to the English level of the user and thus, can behave differently in relation to a native English user. Results can be monolingual for the native user, while results can be bilingual for the ESL user. Additionally the suggestions can be re-ranked by English comprehension level, and features can be turned on and off as appropriate, such as “Pinyin” transliteration-based input for ESL Chinese users, for example.

For ESL users, a need solved by the disclosed architecture is choosing better content words. The detection and correction of poor word choice is a principal challenge in computational linguistics, and word choice errors are the number one mistake made by English language learners.

In general, at least the following capabilities are provided. The disclosed architecture utilizes web search implicitly to assist users write better and more productively. The architecture extends the authoring experience of applications of office suite applications which can draw on a web search engine to offer contextual suggestions for revision, word auto-complete or text prediction, for example. Additionally, web-based research and reference to users is enabled as the user writes or revises text.

More specifically, suggestions are made to a user as to how to complete a phrase or sentence using data from networks such as the Internet or intranet, as to how a user how revises a word or phrase in an already-written sentence using data from the network, as to problems in writing style/writing rules, and so on. Paragraph analysis is performed to find improper language usage or errors. Prediction and revision suggestions are extracted from web search or enterprise (intranet) search document summaries (snippets), and intent of the user to obtain word completion, revision assistance, and prediction suggestions is identified.

Tooltips are generated from Internet or intranet data to provide reference, research, and usage examples. Implicit and explicit methods are employed to determine when to trigger suggestions (e.g., writer's block detection (implicit), keyboard shortcut (explicit), etc.).

The architecture is amenable for multi-lingual users. Accordingly, second-language users can be inferred, and bilingual inline results obtained. Suggestions by an inferred language comprehension level (e.g., English) can be ranked. A feature referred to as web sort can rank suggestions by statistical occurrence in a large corpus. Web sort assists users as a social proof with implicit collocation information.

Word processor auto-complete suggestions are provided that draw on context (nearby words), prefix matching, wild card, and fuzzy matching (e.g., phonetic search, spelling checking, prefix matching, and transliteration). Additionally, automatic bibliographic citation is provided as well as application suite integration (e.g., office suites).

The architecture offers in-place suggestions to users when writing text such as in documents and emails, based on implicit search techniques. The architecture senses the current user context while writing, guesses user intent, and aims to offer trustworthy suggestions illustrated with real-world example sentences, definitions, and helpful research information. This capability can be activated manually by input device control such as keyboard shortcut and/or configured in ambient mode to automatically activate when the architecture senses, for example, that the user hits writer block.

Several results can be provided while the user is writing and reviewing. The results can be statistically ranked by using a web-scale language model, for example. In different scenarios, based on the user behavior, the architecture intelligently returns different results in the user context. This is described and illustrated in detail hereinbelow.

On mouse-over (also related to hovering, or dwell of a pointing device cursor on specific content) of a suggested word or phrase, such as in revision or auto-complete scenarios, a popup tooltip with web-mined usage and reference information can be provided. In one implementation, three sources that can be used are search engines, dictionaries, and web n-gram services to provide reference in the popup. However, it is to be understood that other or different combinations of services can be employed.

The popup tooltip contains a substantial set of dictionary information for the word, for instance, explanation, thesaurus, and example sentences, the set of information which is helpful in understanding the meaning and usage of the word. If the suggestion is an expression, such as in prediction scenarios, the popup tooltip contains search result snippets or blurb from an online source such as a dictionary and/or encyclopedia. Links are also provided to facilitate further investigation. In high confidence predictions, instant answers can be displayed, which helps the user research while writing.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

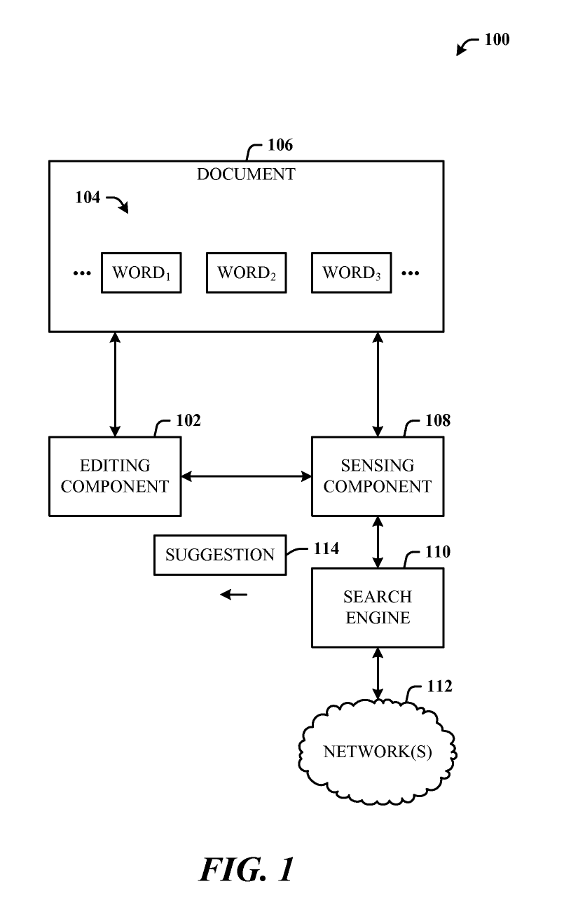

FIG. 1 illustrates an assistance system 100 in accordance with the disclosed architecture. The system 100 can include an editing component 102 for writing and editing words 104 in a document 106, and a sensing component 108 that interacts with a network search engine 110 of a network 112 to return a suggestion 114 to the editing component 102 to suggest a word or multiple words related to the writing and the editing in the document 106 by a user.

Note that herein, a document refers to any multi-line text input area for any application, whether a text area field within a webpage, an editing window for a chat client (e.g., instant messaging client, etc.), and/or any editing surfaces within office suite authoring programs (e.g., email clients, word processors, note-taking software and presentation software). Additionally, the disclosed architecture can operate within mobile text input areas, such as when authoring an SMS (short message service) text message, for example.

The suggestion 114 can relate to completion of a phrase or sentence using data (e.g., web pages, content, results summaries, etc.) from the network 112. The suggestion 114 can relate to revision of a word or phrase in a sentence using data from the network 112. The suggestion 114 can relate to analysis of a paragraph to find and suggest solutions to improper language usage and errors. The suggestion 114 can relate to changes in sentence structure associated with writing style and according to writing rules.

The sensing component 108 extracts suggestions from at least one of Internet search or intranet search documents, the suggestions related to prediction of word usage, auto-complete of a partial word, and revision of a word. The sensing component 108 senses that the user is a second-language user based on user input via the editing component 102 and provides suggested multi-lingual inline results. The sensing component 108 identifies user intent to obtain data for at least one of word completion, revision assistance, or prediction suggestions. The sensing component 108 can also initiate generation of the suggestion based on triggers that include implicit and explicit user interaction.

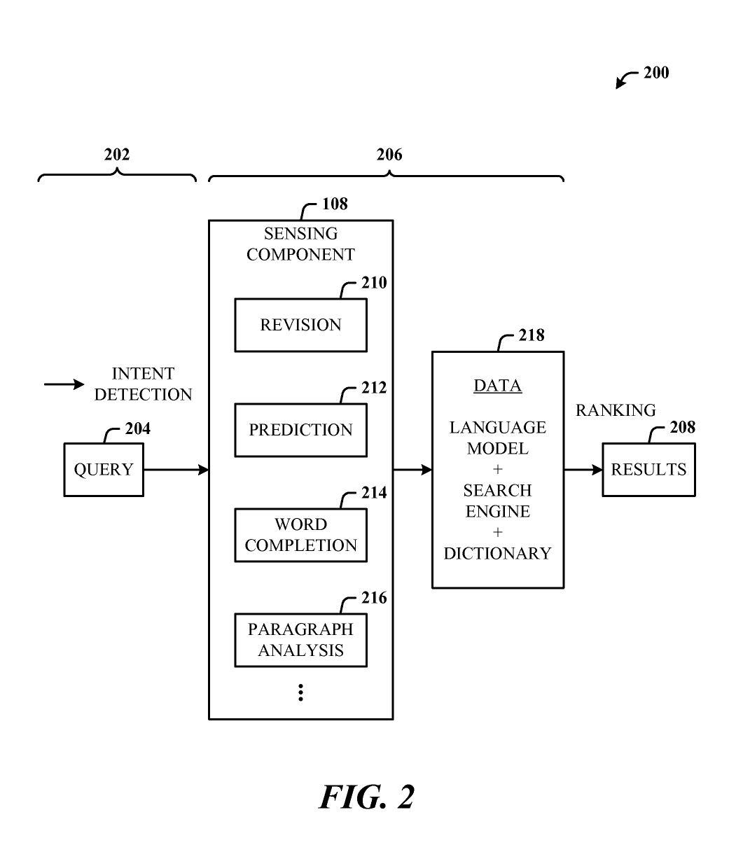

FIG. 2 illustrates a high level diagram of an assistance system 200 in accordance with the disclosed architecture. A user interface (UI) layer 202 (not shown) is provided as a document authoring surface (e.g., the editing component 102 such as a word processing application, or other applications that allow textual input and editing). The UI layer 202 captures user intent and formulates a query 204 to a logic layer 206 and displays results 208. The logic layer 206 can include a cloud-type application that queries, analyzes, and manipulates returned data from web services to answer requests by the UI layer 202. The logic layer 206 can include the sensing component 108, which includes algorithms for revision 210, prediction 212, word completion 214, paragraph analysis 216, and so on.

The data 218 from which the results 208 can be obtained include web services such as associated with a language model (e.g., a web-scale model) that provides n-gram services, a search engine, and a dictionary (e.g., web-mined bilingual dictionary, sample sentences, and advanced auto-complete).

The UI layer 202 can handle intent detection, which decides when to invoke different suggestion types: revision 210, prediction 212, word completion 214 (e.g., auto-complete), and/or paragraph analysis 216. Additionally, the UI layer 202 can be responsible for detecting whether or not to show bilingual results. The UI layer 202 primarily implements intent detection through hooks into a word processing object model (OM). The OM provides information about the context of the document, which enables the application logic to make decisions on information to call and enable n-gram search.

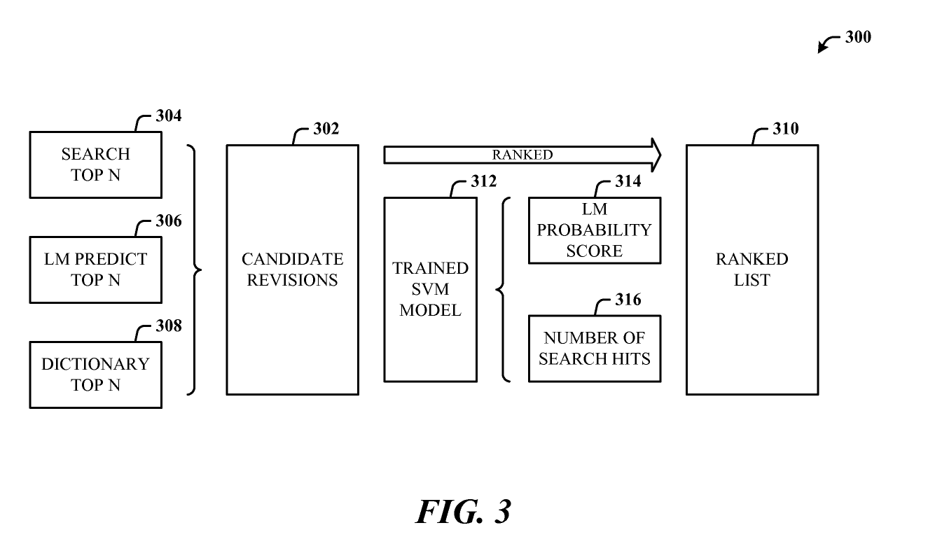

FIG. 3 illustrates an exemplary algorithm 300 for revision processing. Revision suggestions include selecting an alternative word from previously written prose that might sound natural to a native speaker and provide improved flow. The algorithm 300 generates candidate revisions based on the top N search results 304, the top N words from language model prediction 306, and the top N words from a dictionary 308. The candidate revisions 302 can then be ranked and output as a ranked list 310. The ranking can be obtained using a trained support vector machine (SVM) 312, which outputs a language model probability score 314 and the number of search hits 316. Note that the use of a SVM 312 is just one technique for obtaining the ranked list.

The calculation for the language model probability score 314 for a query sentence with candidate w3 in a sentence w1 w2 w3 w4 w5, can be the following:

Score=P(w1)*P(w2|w1)*P(w3|w1,w2)*P(w4|w2,w3)*P(w5|w3,w4)
where P is the probability.

Revision comprises a sliding web query plus snippet analysis technique, which can simulate wild cards of high order n-grams and fill in phrasal suggestions, as opposed to single words used in a typical n-gram search with a language model. Using the word processing OM, at most, the surrounding trigrams of a word under the cursor can be used in the formulation of an altered query to a web search engine. The returned document snippets are mined on-the-fly to determine the candidate revisions 302. The candidate revisions are then joined with the adjacent words of the sentence to create another trigram, which are then queried against the N-gram services language model. Using a smoothed probabilistic model, the candidate revisions 302 are ranked and, if below a certain heuristic threshold, are considered noise and removed.

The data redundancy in the network makes the context (proximity) around the word in question sufficient to find alternatives that spur new thinking. This is useful for ESL users who make word choice errors because a synonym of erroneous content is still wrong. For native English users, however, a thesaurus in query expansion could be used.

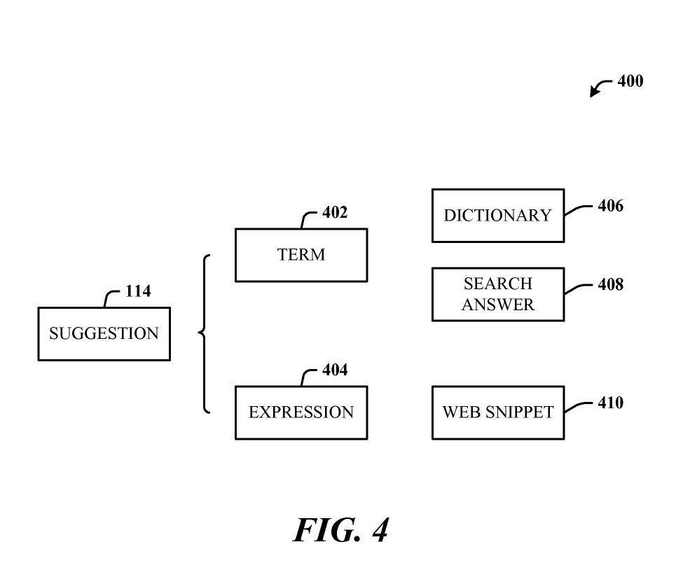

FIG. 4 illustrates a system 400 of tooltip providers. The suggestion 114 can be a term 402 and/or an expression 404. The suggestion 114 as a term 402 is the simple case, and is described herein. However, where the suggestion 114 is the expression 404 (multiple terms), the results cannot be obtained solely from a provider such as dictionary 406. Accordingly, other providers such as the search answer provider 408 and web snippet provider 410 can be utilized also serve as sources of the tooltip information. In other words, if the suggestion is predicting several words or more of a sentence, the does allow lookup in the dictionary 406. Thus, the tooltip can include snippets from the network (e.g., Internet, intranet) to give the user additional context in which to explain the word. For example, online website information document snippets can provide an encyclopedia for explaining what a particular suggestion means. This can also include a product being searched. The documents from the product page can assist in explaining what that word means.

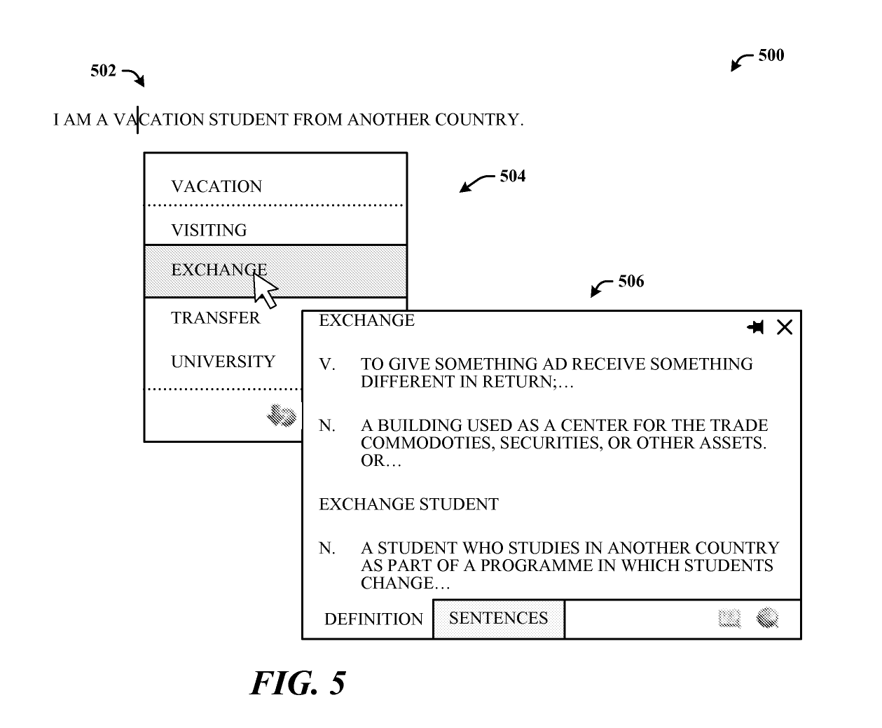

FIG. 5 illustrates an example user interface 500 for revision and tooltip with contextual network-mined reference. Consider the following sentence 502 with a word choice error: “I am a vacation student from another country.” The choice of the terms “vacation student” is likely the result of a translation (or transfer) error, but not a spelling mistake. The disclosed architecture provides alternative words once the user clicks within the sentence 502. For example, moving the cursor on the term “vacation” suggests, as shown in the suggestion panel 504, the terms “visiting,” “exchange,” “transfer,” and “university.”

With respect to tooltips, and continuing with the example sentence, “I am a vacation student from another country”, an ESL user can infer the word “vacation” from the user's first language (L1). If the user puts the cursor on the word (term) “vacation”, the system performs search query with at most a trigram window of words before and after the word. In such cases, conventional query expansion using synonyms of the word may not work; however, the surrounding context of the word does help. For example, the following query “I am a” AND (logical) “student from another” can be formulated. Extracting the snippets based on frequency, terms such as “exchange”, “visiting”, and “transfer” can be suggested. Additionally, based on the user's first language, inline translations can be provided so the user knows the word being selected is the word expected. Additionally, the user can be more confident in the word selection by reading the bilingual web-based examples and definitions in the tooltip 506.

Clicking a suggestion in the suggestion panel 504 automatically replaces the word under the cursor (e.g., vacation), and can also trigger a grammar checker. For example, if selecting the suggestion “exchange”, the grammar checker will also replace the word “a” with the word “an”.

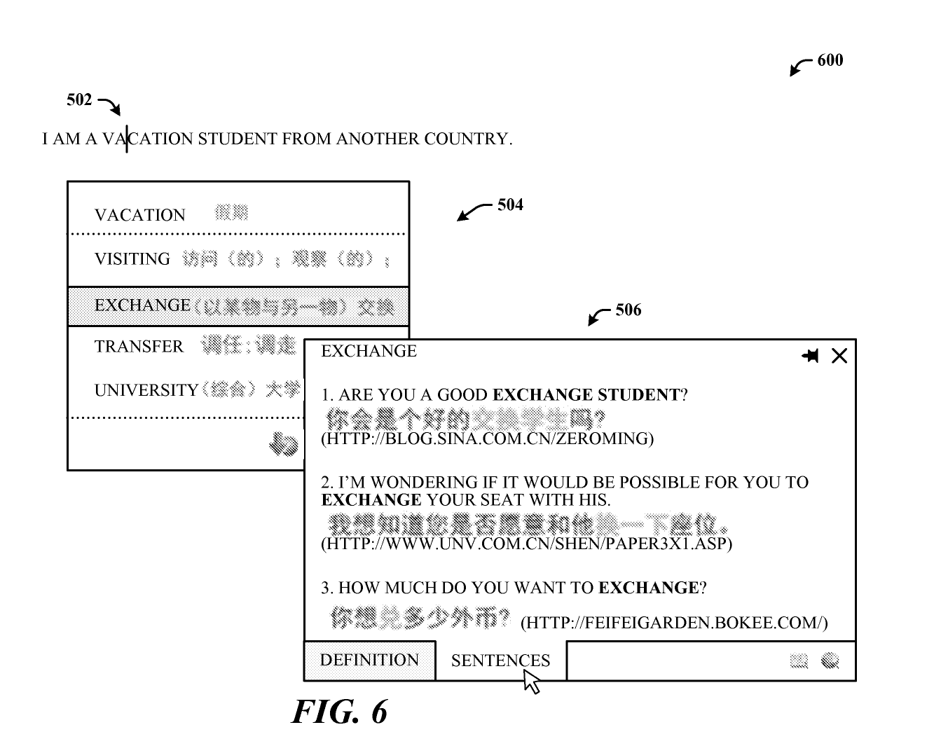

FIG. 6 illustrates a user interface 600 that presents a second language of the user. If the user is detected to be a Chinese native, the results in the suggestion panel 504 and tooltip panel 506 can be presented in at least two languages: English, and the native language (e.g., Chinese) of the user, to show bilingual suggestions and tooltips with contextual web-mined sentences.

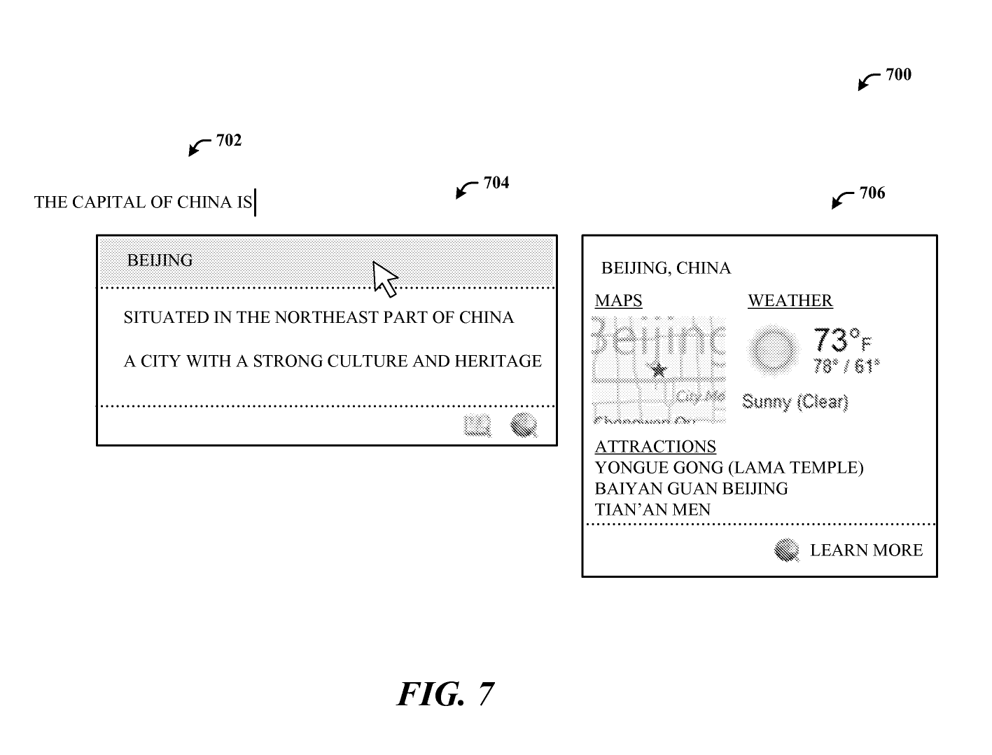

FIG. 7 illustrates a user interface 700 for sentence completion and inline research while writing. Here, the user writes a partial sentence 702, “The capital of China is . . . ” and the system dynamically processes the word string to suggest three suggestions 704 for sentence completion: “Beijing”, “situated in the northeast part of China”, and “a city with a strong culture and heritage”. If the user selects or hovers the cursor over the suggestion “Beijing”, additional information 706 related to Beijing can be presented, such as a map, weather information, attractions, and a link to additional related information.

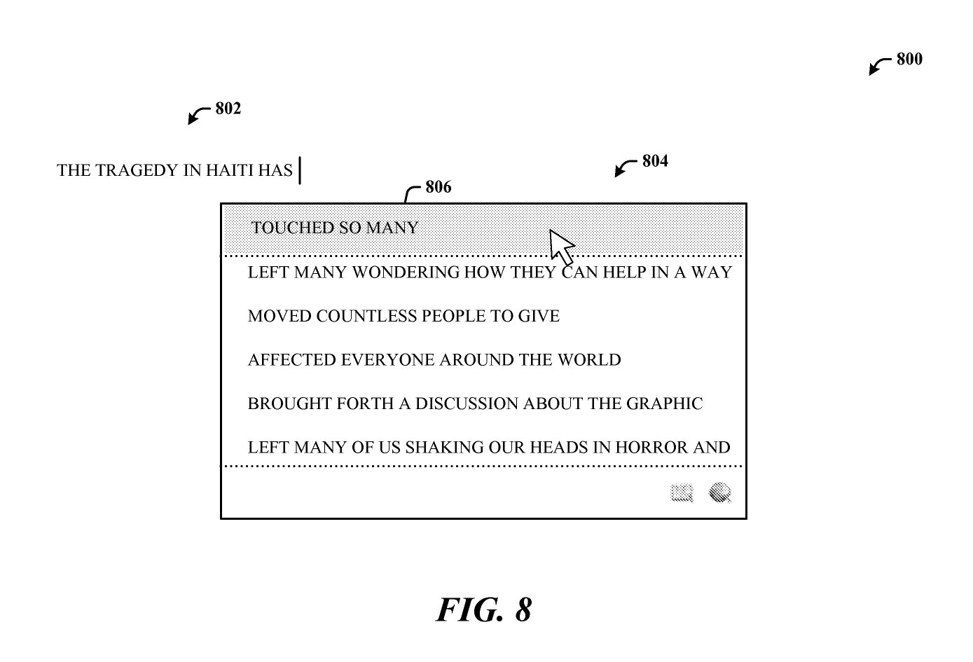

FIG. 8 illustrates a user interface 800 for predictive suggestions. Predictive suggestions relate to what to write next, and can be a word, phrase, or expression. Predicting a sentence works in a similar way to revision except that the only n-grams used for the query are before the last word of the sentence. The literal queries are formulated, issued, and the resulting snippets are parsed. By employing higher precision rather than recall, many snippets will be discarded. Since there can be a high loss ratio of the snippet discarded relative to the snippets used, a web query contains enough raw materials to process and suggest a minimum number (e.g., at least fifty) of snippets at a time. The parsing of snippets focuses on finding the space between the last gram of the query and the terminal punctuation, or the equivalent semantics, in the snippet. As in the revision case, a smoothed web-scale language model can be used to rank and filter the results.

Here, the user enters a partial sentence 802, “The tragedy in Haiti has . . . ” and the system predicts a set of suggestions 804 from which the user can choose to select one to add to the existing word set or to add a different word string.

In other words, on mouse-over of a suggested word or phrase (e.g., “touched so many”), such as in revision or auto-complete scenarios, the system provides a popup 806 (that lists the suggestions 804) with web-mined usage and reference information. This is helpful in deciding which suggestion is most relevant. If the suggestion is an expression, such as in prediction scenarios, the popup 806 contains search result snippets, such as blurb from an online encyclopedia. In high confidence predictions, as depicted in FIG. 7, instant answers can be displayed. This helps the user research while writing. If the user is a non-native English speaker, such as a Chinese speaker, all suggestions can be presented in both English and Chinese.

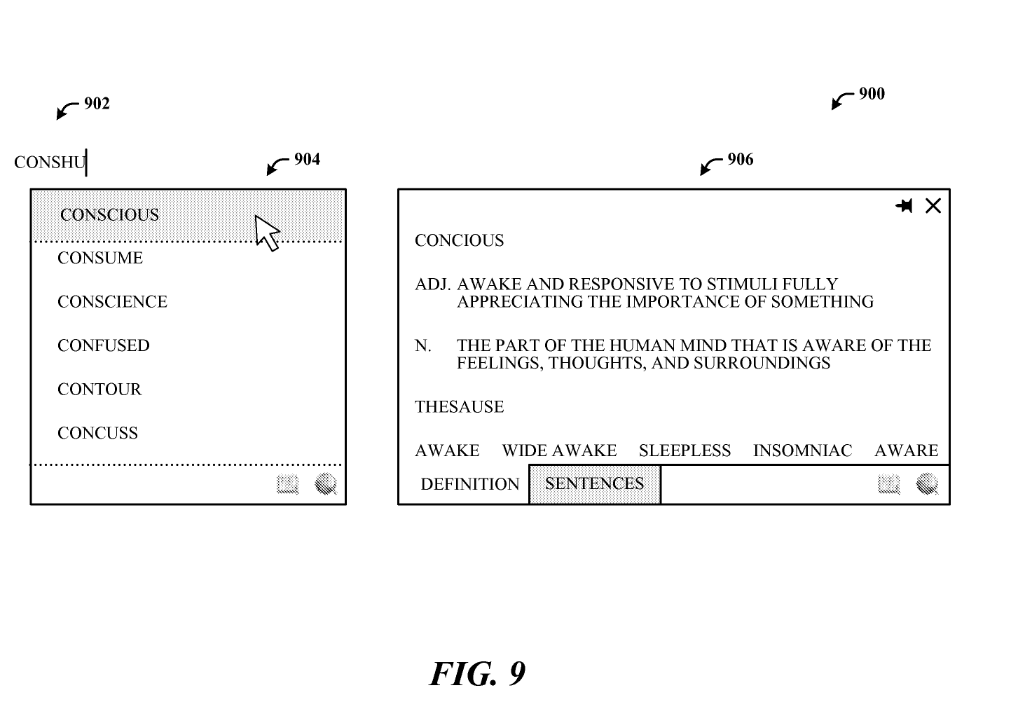

FIG. 9 illustrates a user interface 900 for word complete suggestions. Word complete suggestions help to finish the current word, even if the words forms part of the surrounding words, is incomplete, written in another language, or spelled wrong entirely. Here, phonetic auto-complete is performed as part of the word complete. The user enters a misspelled partial word 902 “conshu”, and the system returns suggestions 904. When the mouse hovers over the suggestion “conscious”, a tooltip popup 906 is presented that provides additional information about the word, usage, definition, thesaurus words, etc., such as found in a dictionary and a thesaurus, for example.

Intuitive auto-complete is contextual. The proceeding word in the document is used in the auto-complete queries. The suggestions 904 can be a composition of the web service providers such as dictionary and auto-complete services. The combined features of word auto-complete make the system context aware, with the ability to match based on word prefix, and, if that fails, invoke a fuzzy match mode. Spelling (edit distance) and phonetic search drawn from the dictionary service enables such a feature. For ESL users, first-language line translations are offered in the auto-complete to assist the user in deciding on the optimum choice. Such users can also type directly in their native language and have the results transliterated in a similar manner to how an input method editor (IME) works. The dictionary service can also implement various wild cards, allowing for multiple characters such as “?”, “*”, and part-of-speech placeholders.

Word auto-complete is pervasive in handsets to mitigate the lack of attached full size keyboards utilized with typical computer. However, with the emergence of “slate computing,” which are full function computers without keyboards, using fewer keystrokes in traditional desktop software is a relevant need.

The word auto-complete provided herein attempts to complete the word in the user's mind, not necessarily the word literally being written in the document. This means that a word can be auto-completed with fewer keystrokes than that offered by state-of-the-art auto-complete systems, even if part of the word is spelled nearly entirely wrong, or written in a different language from the adjacent text.

Additionally, because the disclosed architecture is based on the vastness of networks such as the Internet, both new words and domain-specific words can also be completed. Moreover, to make the auto-complete experience even more powerful while writing, the disclosed architecture enables the utilization of multiple wild cards such as the asterisk (*) character which represents zero or more characters, and the question mark character (?) which represents zero or one character. This makes auto-complete not just useful for handset or slate form factors, but the desktop computer as well.

The implementation of phonetic complete not only suggests word completion based on phonetics, but disambiguates between “conscience” and “conscious,” enabling the user to accurately find the desired word.

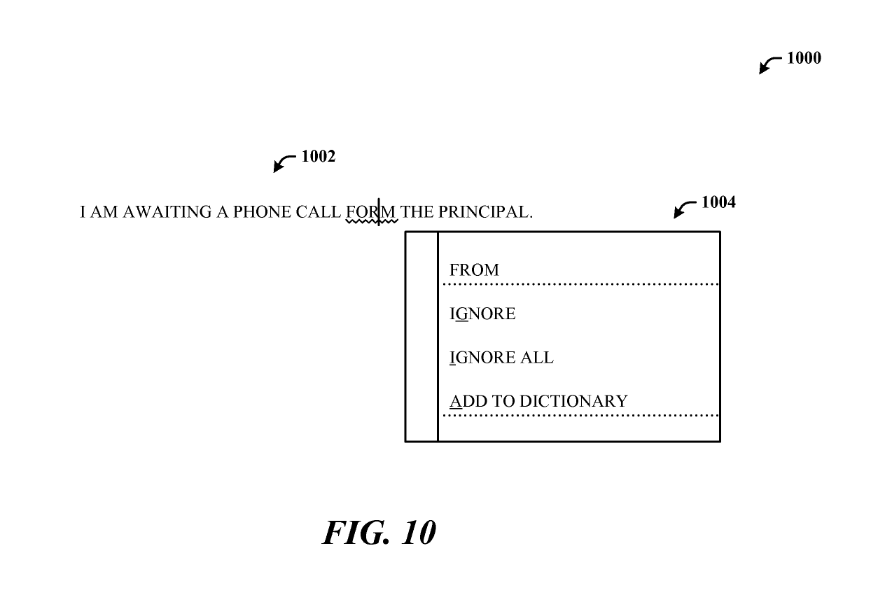

FIG. 10 illustrates a user interface 1000 for a contextual speller. Although humans may consider a poor word choice unnatural or confusing, this confusion may not be noticed by a computer program, when the program relies on predetermined rules about syntactic features. The disclosed architecture utilizes a context sensitive speller that recognizes a misspelled that also happens to form another valid word which, however, is wrong in the given context.

For example, referring again to FIG. 5, consider the snippet with a word choice error “I am a vacation student from another country.” The choice of the terms “vacation student” is likely the result of a translation (transfer) error, but not a spelling mistake. Hence, conventional checkers will not be able to flag the misused term “vacation”. In contrast, the disclosed architecture provides alternative words once the user clicks within the above sentence. For example, placing the cursor on the word “vacation” will result in the suggestions “visiting,” “exchange,” “transfer,” and “university”, and the associated tooltip 506.

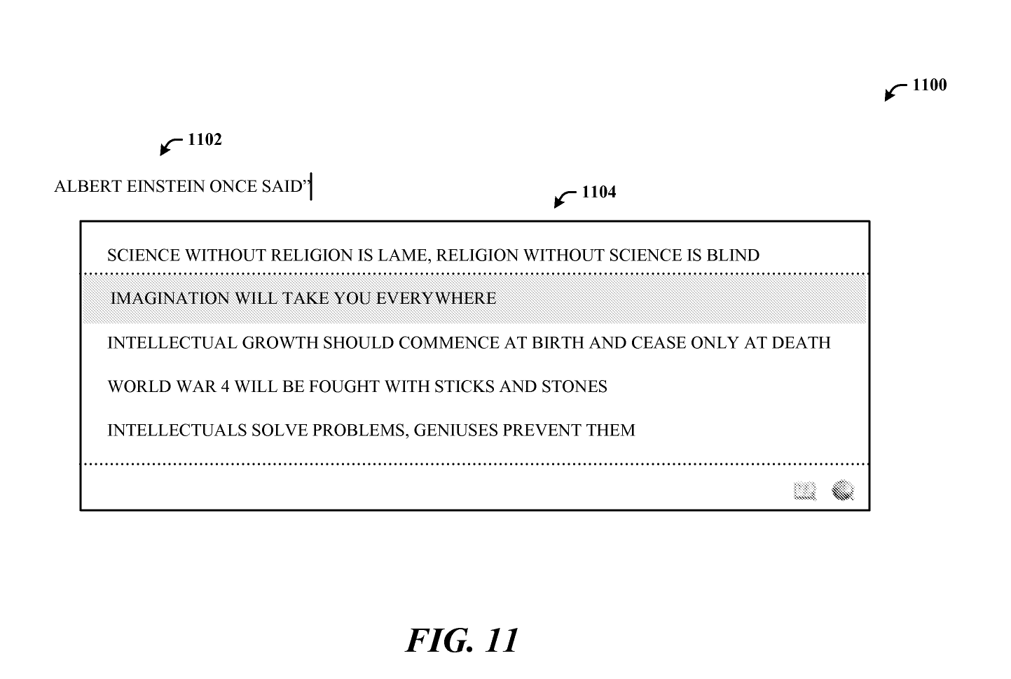

FIG. 11 illustrates a user interface 1100 for quotation sentence completion. For native English speakers, users desire inspiration to unlock writer's block, easy access to quotations for citation, reference on unfamiliar terms, and assistance in typing new or technical words. As illustrated in the example of FIG. 8, a particular sentence can require delicate phrasing to complete, thereby pushing the limits of a user's linguistic repertoire. The disclosed architecture can inspires a writer to complete a thought by matching part of what the user wrote against the vast number of sentences already written by an equally vast number of network users.

Alternatively, users can choose to insert exactly what was suggested. Doing so automatically creates a properly formatted citation in bibliography feature if supported by the application which hosts the document. Consider, for example, insertion of an Einstein quote the user may have browsed and discovered while writing followed by insertion of a citation for the quote. Here, the user enters a partial quotation sentence 1102 “Albert Einstein once said . . . ” and the system returns suggestions 1104 mined from the network(s) (e.g., the Internet, an intranet, etc.). The user can then select one of the suggestions 1104 to complete the quotation sentence.

In an alternative implementation, rather than inserting a completion verbatim, an automatically reworded completion can be inserted using a paraphrasing system as an alternative option, and a generated citation, if desired.

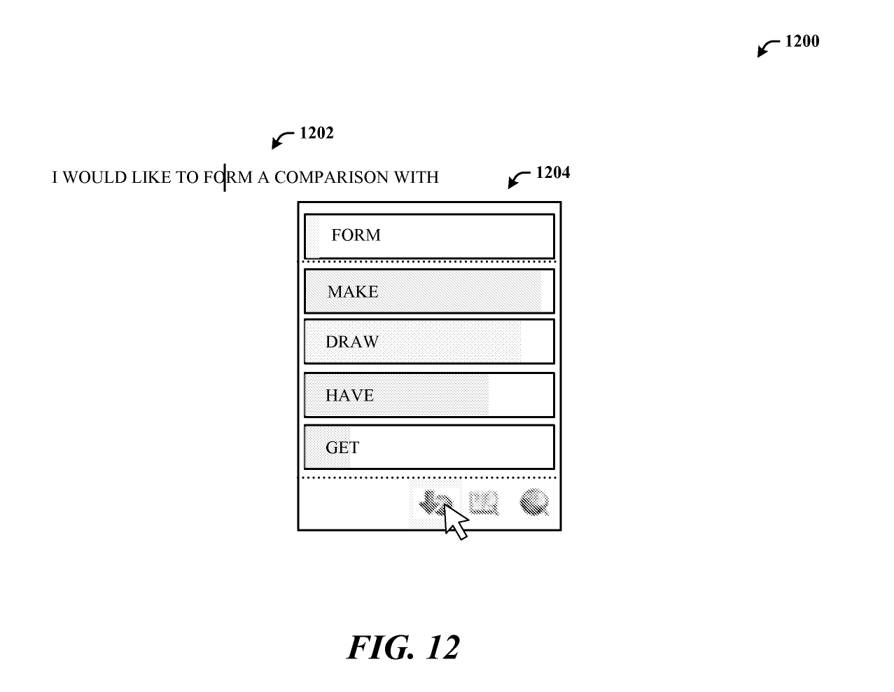

FIG. 12 illustrates a user interface 1200 for a web sort feature. The disclosed architecture provides the user the ability to sort suggestion results by web document frequency in an effort to satisfy a user's inherent need for social proof. The approach to implement can be abstract, such as using document hit count or language model probability, or both.

The principle of the “social proof” concept is to view a behavior as correct in a given situation to the degree that others are viewed performing the behavior. By this definition, web search hit counts can be considered a social proof in the writing process because the frequency can differentiate candidate terms by exposing essentially a degree of popularity.

Although there are known issues in trusting the linguistic value of search hit counts, using the search hit count for writing is widely considered common practice especially among ESL users. For example, if there is uncertainty about using “form” or “make” in an expression 1202 “I would like to form/make a comparison with . . . ”, a user might search the web with some subset of the query, looking for hit counts to determine which is more popular. In this case “like to make a comparison” can show a significantly greater number of results than “like to form a comparison.” This form of social proof can be surfaced as an opt-in feature called web sort, which uses a sliding range of n-grams to search, and ultimately, sort the suggestions by web count frequency, as illustrated with progress bars. In this way, the feature can essentially expose collocation information. Improvements in the accuracy of collocations using different statistical methods are described hereinbelow.

Research shows that leveraging web-scale smoothed n-gram language models (LM) can significantly outperform web search hit counts in terms of accuracy and therefore, can provide more precise collocations. Therefore, the disclosed architecture can alternatively utilize LMs instead of web search, or even other statistical methods.

The disclosed architecture also addresses ESL errors related to collocation problems. A collocation is a collection of words that usually appear together, as found in normal widespread usage. To native English speakers, these word groups sound natural. However, for ESL users, collocations are notoriously difficult to wield because of limited exposure to large amounts of English text.

For example, native English speakers might say “watch TV,” while ESL learners might say “see TV.” Grammatically speaking, these are both correct; however, the word choice in the latter is incorrect because “see” and “TV” do not often pair together in prose. Although collocation dictionaries exist, there are simply too many groupings to enumerate offline.

The disclosed architecture utilizes the web (and possibly other networks) to find a vast number of collocations. Additionally, explicit collocation dictionaries are difficult to use because these dictionaries require users to sift through deep ontologies and leverage linguistic insight. Contrariwise, the disclosed architecture infers collocation suggestions based on the writer's current context, suggesting terms which can effectively be sorted by occurrences found in web-scale corpora. This is exemplified in FIG. 12, where suggestions 1204 for the word “form” are obtained from the massive amounts of web data.

It is to be understood that context (word proximity) is utilized in finding collocations, since, for example, on the web, “see TV” could be part of “Must See TV”, which is a regularly occurring phrase. Therefore, widening the window of terms to search (before and after the term “form” reduces the occurrences of noisy collocation suggestions.

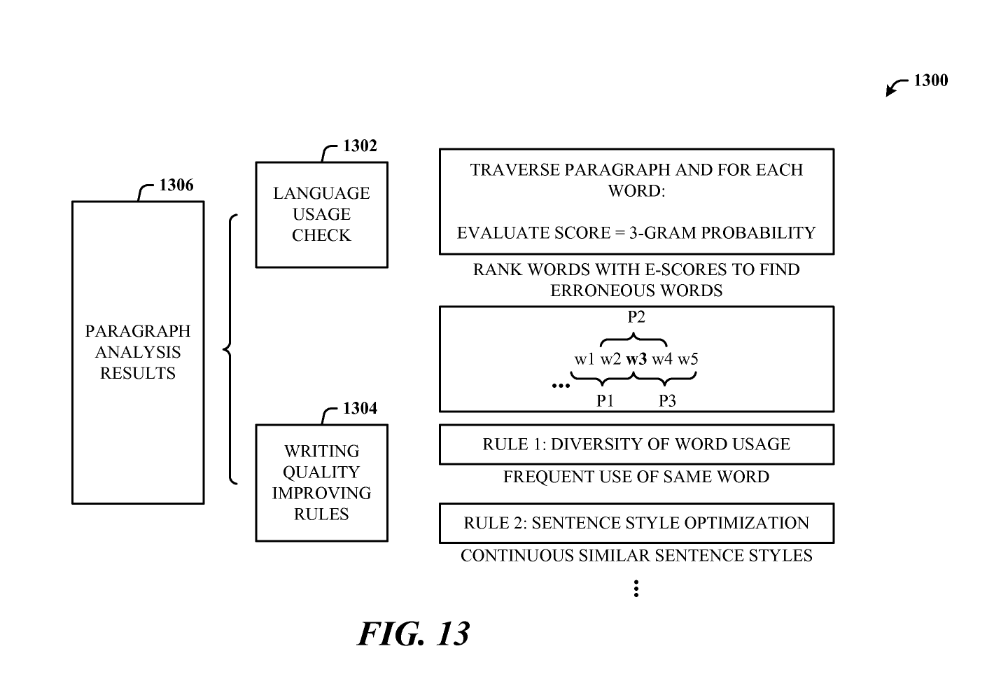

FIG. 13 illustrates a paragraph analysis algorithm 1300 to find language usage mistakes and semantic errors. The paragraph analysis feature of helps the user find language usage mistakes and semantic errors, including grammar and collocation problems. The method “touches-up” every tri-gram in the paragraph and calculates probability scores for the tri-grams. Additionally, the paragraph analysis feature can be employed with heuristic language rules to help detect writing quality mistakes. For example, when the same word or expression appears excessively inside a paragraph, the architecture suggests to the user to replace some of the usages with web-culled suggestions, synonyms, or similar expressions.

The example implementation of the algorithm 1300 can include a language usage check 1302 and writing quality improving rules 1304. The output is paragraph analysis results 1306. The language usage check 1302 can include traversing the paragraph, and for each word, evaluating a score that equates to a tri-gram probability. The words are then ranked with e-scores to find the erroneous words. The rules 1304 applied can include, but are not limited to: diversity of word usage to detect frequency of same word usage, sentence style optimization to look for continuous similar sentence styles, and other rules as desired.

The tip-of-the-tongue (TOT) phenomenon (e.g., the failure to recall a word even though the user is certain to know it) happens to everyone, and occurs more frequently as the user ages. It has been found that people usually know some characteristics about the target word, such as the first letter of the target word or a correlation to sound (e.g., the word rhymes with), and approximately the length of the word.

The disclosed architecture counters TOT because users can utilize its contextual suggestions and auto-complete wild card feature while writing. The user can type a guess for the first letter, and if the suggestions are not adequate, the user can proceed by entering a succession of wildcard characters “?” in order to set the length range for further suggestions. Using a sliding window of n-grams before and after the wildcard characters can provide the context needed for a web-scale language model to narrow down reasonable guesses of the target word.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

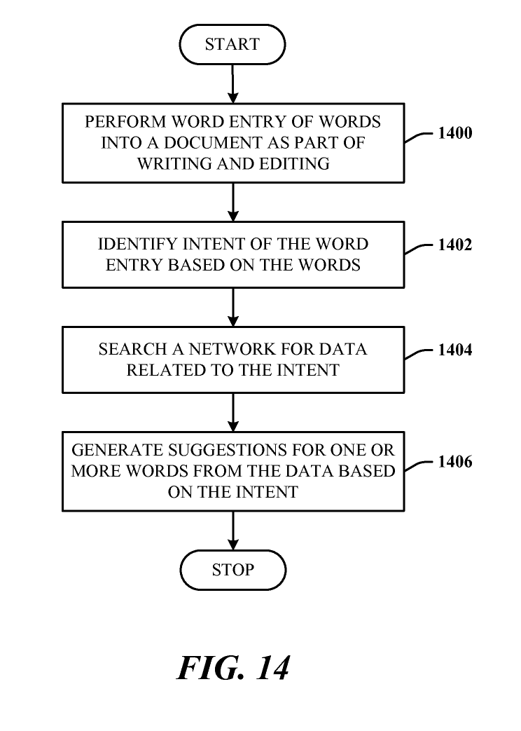

FIG. 14 illustrates a computer-implemented assistance method in accordance with the disclosed architecture. At 1400, word entry of words into a document is performed as part of writing and editing. At 1402, intent of the word entry is identified based on the words. At 1404, a network is searched for data related to the intent. At 1406, suggestions for one or more words are generated from the data based on the intent.

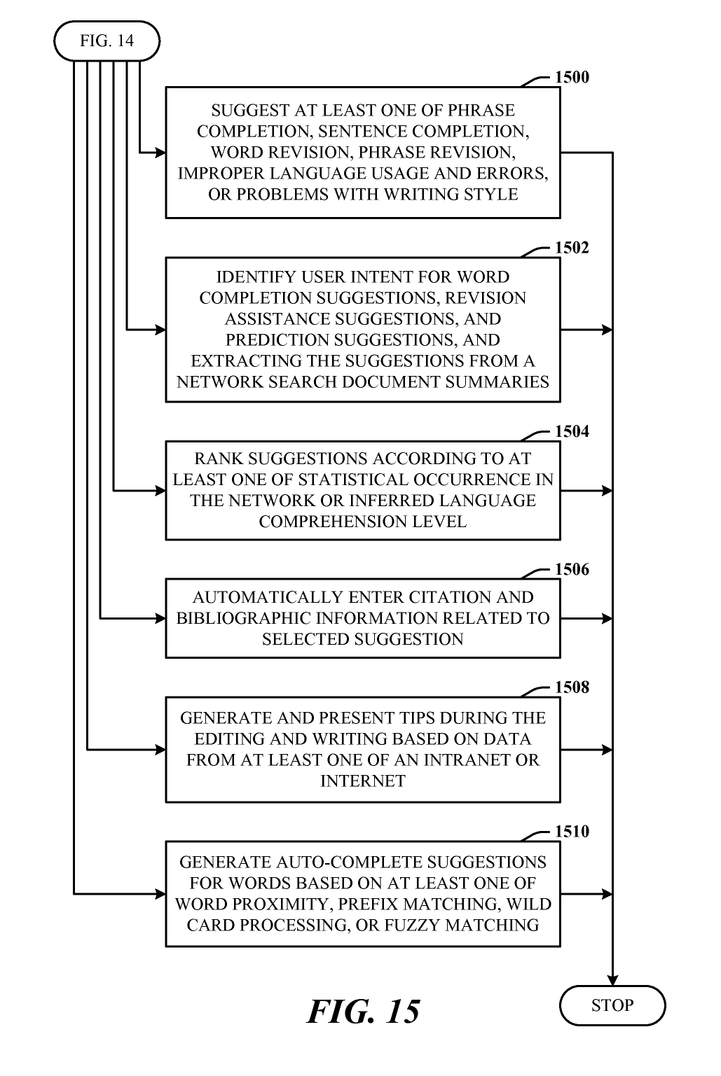

FIG. 15 illustrates further aspects of the method of FIG. 14. Note that the flow indicates that each block can represent a step that can be included, separately or in combination with other blocks, as additional aspects of the method represented by the flow chart of FIG. 14. At 1500, at least one of phrase completion, sentence completion, word revision, phrase revision, improper language usage and errors, or problems with writing style is suggested. At 1502, user intent is identified for word completion suggestions, revision assistance suggestions, prediction suggestions, and extraction of the suggestions from a network search document summaries. At 1504, the suggestions are ranked according to at least one of statistical occurrence in the network or inferred language comprehension level. At 1506, citation and bibliographic information related to a selected suggestion is automatically entered. At 1508, tips are generated and presented during the editing and writing based on data from at least one of an intranet or Internet. At 1510, auto-complete suggestions are generated for words based on at least one of word proximity, prefix matching, wild card processing, or fuzzy matching.

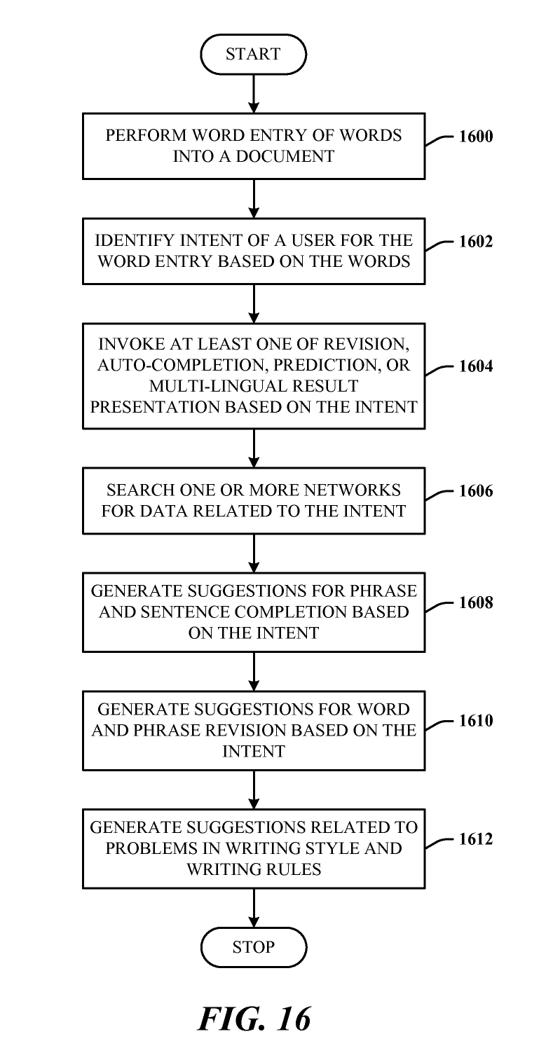

FIG. 16 illustrates an alternative computer-implemented assistance method in accordance with the disclosed architecture. At 1600, word entry of words is performed into a document. At 1602, intent of a user for the word entry is identified based on the words. At 1604, at least one of revision, auto-completion, prediction, or multi-lingual result presentation based on the intent is invoked. At 1606, one or more networks are searched for data related to the intent. At 1608, suggestions are generated for phrase and sentence completion based on the intent. At 1610, suggestions are generated for word and phrase revision based on the intent. At 1612, suggestions are generated related to problems in writing style and writing rules.

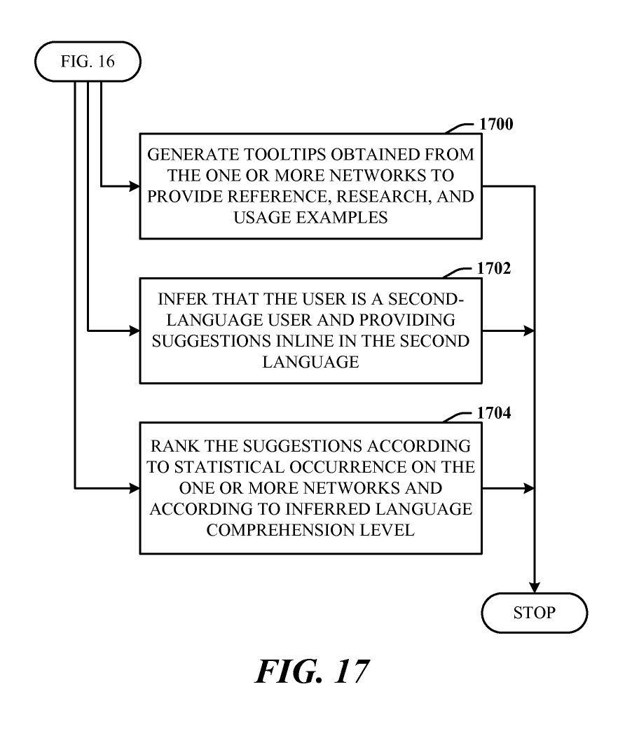

FIG. 17 illustrates further aspects of the method of FIG. 16. Note that the flow indicates that each block can represent a step that can be included, separately or in combination with other blocks, as additional aspects of the method represented by the flow chart of FIG. 16. At 1700, tooltips obtained from the one or more networks are generated to provide reference, research, and usage examples. At 1702, it is inferred that the user is a second-language user and suggestions are provided inline in the second language. At 1704, the suggestions are ranked according to statistical occurrence on the one or more networks and according to inferred language comprehension level.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

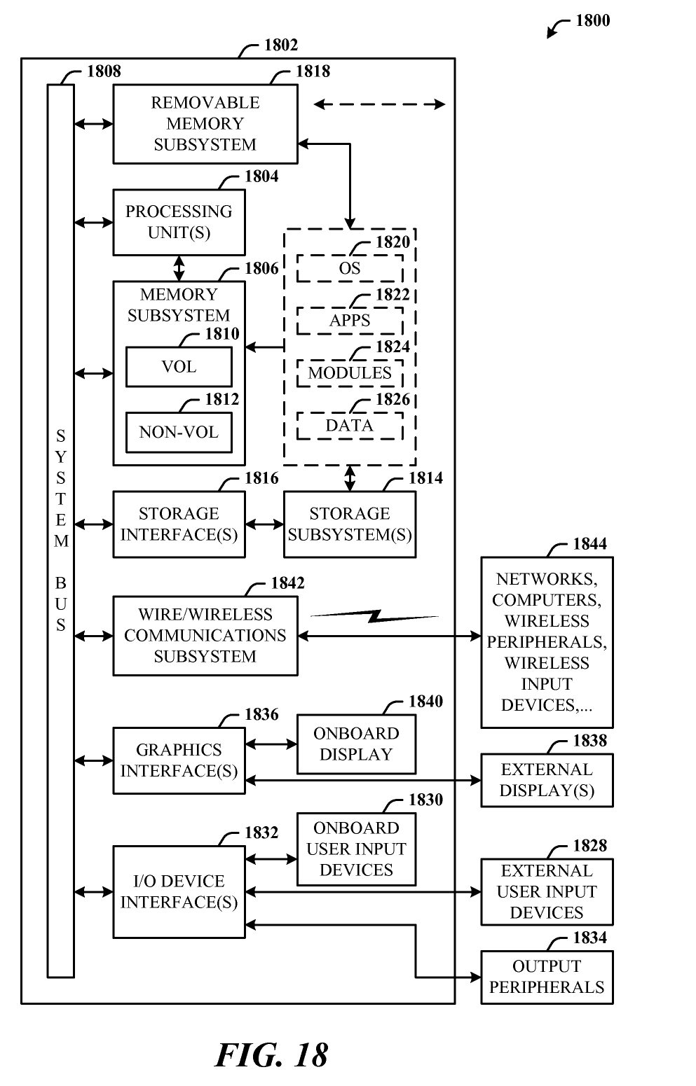

Referring now to FIG. 18, there is illustrated a block diagram of a computing system 1800 that executes writing assistance and searching in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 18 and the following description are intended to provide a brief, general description of the suitable computing system 1800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1800 for implementing various aspects includes the computer 1802 having processing unit(s) 1804, a computer-readable storage such as a system memory 1806, and a system bus 1808. The processing unit(s) 1804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1806 can include computer-readable storage (physical storage media) such as a volatile (VOL) memory 1810 (e.g., random access memory (RAM)) and non-volatile memory (NON-VOL) 1812 (e.g., ROM, EPROM, EEPROM, etc.). A basic input/output system (BIOS) can be stored in the non-volatile memory 1812, and includes the basic routines that facilitate the communication of data and signals between components within the computer 1802, such as during startup. The volatile memory 1810 can also include a high-speed RAM such as static RAM for caching data.

The system bus 1808 provides an interface for system components including, but not limited to, the system memory 1806 to the processing unit(s) 1804. The system bus 1808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1802 further includes machine readable storage subsystem(s) 1814 and storage interface(s) 1816 for interfacing the storage subsystem(s) 1814 to the system bus 1808 and other desired computer components. The storage subsystem(s) 1814 (physical storage media) can include one or more of a hard disk drive (HDD), a magnetic floppy disk drive (FDD), and/or optical disk storage drive (e.g., a CD-ROM drive DVD drive), for example. The storage interface(s) 1816 can include interface technologies such as EIDE, ATA, SATA, and IEEE 1394, for example.

One or more programs and data can be stored in the memory subsystem 1806, a machine readable and removable memory subsystem 1818 (e.g., flash drive form factor technology), and/or the storage subsystem(s) 1814 (e.g., optical, magnetic, solid state), including an operating system 1820, one or more application programs 1822, other program modules 1824, and program data 1826.

The operating system 1820, one or more application programs 1822, other program modules 1824, and/or program data 1826 can include the entities and components of the system 100 of FIG. 1, the entities and components of the system 200 of FIG. 2, the algorithm 300 of FIG. 3, the entities and components of the system 400 of FIG. 4, the user interfaces associated with of FIGS. 5-12, the algorithm 1300 of FIG. 13, and the methods represented by the flowcharts of FIGS. 14-17, for example.

Generally, programs include routines, methods, data structures, other software components, etc., that perform particular tasks or implement particular abstract data types. All or portions of the operating system 1820, applications 1822, modules 1824, and/or data 1826 can also be cached in memory such as the volatile memory 1810, for example. It is to be appreciated that the disclosed architecture can be implemented with various commercially available operating systems or combinations of operating systems (e.g., as virtual machines).

The storage subsystem(s) 1814 and memory subsystems (1806 and 1818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1802 and includes volatile and non-volatile internal and/or external media that is removable or non-removable. For the computer 1802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1802, programs, and data using external user input devices 1828 such as a keyboard and a mouse. Other external user input devices 1828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1802, programs, and data using onboard user input devices 1830 such a touchpad, microphone, keyboard, etc., where the computer 1802 is a portable computer, for example. These and other input devices are connected to the processing unit(s) 1804 through input/output (I/O) device interface(s) 1832 via the system bus 1808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1832 also facilitate the use of output peripherals 1834 such as printers, audio devices, camera devices, and so on, such as a sound card and/or onboard audio processing capability.

One or more graphics interface(s) 1836 (also commonly referred to as a graphics processing unit (GPU)) provide graphics and video signals between the computer 1802 and external display(s) 1838 (e.g., LCD, plasma) and/or onboard displays 1840 (e.g., for portable computer). The graphics interface(s) 1836 can also be manufactured as part of the computer system board.

The computer 1802 can operate in a networked environment (e.g., IP-based) using logical connections via a wired/wireless communications subsystem 1842 to one or more networks and/or other computers. The other computers can include workstations, servers, routers, personal computers, microprocessor-based entertainment appliances, peer devices or other common network nodes, and typically include many or all of the elements described relative to the computer 1802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1802 connects to the network via a wired/wireless communication subsystem 1842 (e.g., a network interface adapter, onboard transceiver subsystem, etc.) to communicate with wired/wireless networks, wired/wireless printers, wired/wireless input devices 1844, and so on. The computer 1802 can include a modem or other means for establishing communications over the network. In a networked environment, programs and data relative to the computer 1802 can be stored in the remote memory/storage device, as is associated with a distributed system. It will be appreciated that the network connections shown are exemplary and other means of establishing a communications link between the computers can be used.

The computer 1802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer-implemented assistance system, comprising:
an editing component for writing and editing words in a document;
a sensing component that interacts with a network search engine of a network to return a suggestion to the editing component to suggest a word or multiple words related to the writing and the editing in the document by a user; and
a processor that executes computer-executable instructions associated with at least one of the editing component or the sensing component.

2. The system of claim 1, wherein the suggestion relates to completion of a phrase or sentence using data from the network.

3. The system of claim 1, wherein the suggestion relates to revision of a word or phrase in a sentence using data from the network.

4. The system of claim 1, wherein the suggestion relates to analysis of a paragraph to find and suggest solutions to improper language usage and errors.

5. The system of claim 1, wherein the suggestion relates to changes in sentence structure associated with writing style and according to writing rules.

6. The system of claim 1, wherein the sensing component extracts suggestions from at least one of Internet search or intranet search documents, the suggestions related to prediction of word usage, auto-complete of a partial word, and revision of a word.

7. The system of claim 1, wherein the sensing component senses that the user is a second-language user based on user input via the editing component and provides suggested multi-lingual inline results.

8. The system of claim 1, wherein the sensing component identifies user intent to obtain data for at least one of word completion, revision assistance, or prediction suggestions.

9. The system of claim 1, wherein the sensing component initiates generation of the suggestion based on triggers that include implicit and explicit user interaction.

10. A computer-implemented assistance method, comprising acts of:
performing word entry of words into a document as part of writing and editing;
identifying intent of the word entry based on the words;
searching a network for data related to the intent;
generating suggestions for one or more words from the data based on the intent; and
utilizing a processor that executes instructions stored in memory to perform at least one of the acts of performing, identifying, searching, or generating.

11. The method of claim 10, further comprising suggesting at least one of phrase completion, sentence completion, word revision, phrase revision, improper language usage and errors, or problems with writing style.

12. The method of claim 10, further comprising identifying user intent for word completion suggestions, revision assistance suggestions, and prediction suggestions, and extracting the suggestions from a network search document summaries.

13. The method of claim 10, further comprising ranking the suggestions according to at least one of statistical occurrence in the network or inferred language comprehension level.

14. The method of claim 10, further comprising automatically entering citation and bibliographic information related to a selected suggestion.

15. The method of claim 10, further comprising generating and presenting tips during the editing and writing based on data from at least one of an intranet or Internet.

16. The method of claim 10, further comprising generating auto-complete suggestions for words based on at least one of word proximity, prefix matching, wild card processing, or fuzzy matching.

17. A computer-implemented assistance method, comprising acts of:
performing word entry of words into a document;
identifying intent of a user for the word entry based on the words;
invoking at least one of revision, auto-completion, prediction, or multi-lingual result presentation based on the intent;
searching one or more networks for data related to the intent;
generating suggestions for phrase and sentence completion based on the intent;
generating suggestions for word and phrase revision based on the intent;
generating suggestions related to problems in writing style and writing rules; and
utilizing a processor that executes instructions stored in memory to perform at least one of the acts of performing, identifying, invoking, searching, or generating.

18. The method of claim 17, further comprising generating tooltips obtained from the one or more networks to provide reference, research, and usage examples.

19. The method of claim 17, further comprising inferring that the user is a second-language user and providing suggestions inline in the second language.

20. The method of claim 17, further comprising ranking the suggestions according to statistical occurrence on the one or more networks and according to inferred language comprehension level.
